(19) United States
(12) Patent Application Publication
(10) Pub. No.: US 2022/0357446 A1
(43) Pub. Date: Nov. 10, 2022

(54) COMMUNICATION DEVICE AND COMMUNICATION METHOD

(71) Applicant: Sony Semiconductor Solutions Corporation, Kanagawa (JP)

(72) Inventor: Kyoji YOKOYAMA, Kanagawa (JP)

(73) Assignee: Sony Semiconductor Solutions Corporation, Kanagawa (JP)

(21) Appl. No.: 17/623,877

(22) PCT Filed: Jul. 15, 2020
(86) PCT No.: PCT/JP2020/027482

§ 371 Date: Dec. 30, 2021

(30) Foreign Application Priority Data
Aug. 7, 2019 (JP) 2019-145673

(51) Int. Cl. G01S 17/10; G01S 17/87; G01S 17/89; H04B 10/114

(52) U.S. Cl. CPC G01S 17/10; G01S 17/87; G01S 17/89; H04B 10/114

(57) ABSTRACT

A communication device (10-1) according to the present disclosure includes a ToF (time of flight) sensor and a control unit (90). The ToF sensor includes a light emitting unit (31) that emits light to an object (X) to be measured and a light receiving unit (32) that receives light reflected from the object (X) to be measured. The control unit (90) controls the ToF sensor. Furthermore, the control unit (90) emits light for a linking request to another communication device (10-2), from the light emitting unit (31), and receives light being a response to the linking request from the another communication device (10-2), at the light receiving unit (32).

### FIELD

The present disclosure relates to a communication device and a communication method.

### BACKGROUND

There is known a technology to perform a predetermined connection operation for transmission and reception of data between a plurality of communication devices (e.g., see Patent Literature 1).

### CITATION LIST

### Patent Literature

Patent Literature 1: JP 2011-130224 A

### SUMMARY

### Technical Problem

However, the above technology requires complicated connection operation and it is cumbersome for the user to perform the connection operation.

Therefore, the present disclosure proposes a communication device and a communication method that are configured to have a simplified connection operation between communication devices.

### Solution to Problem

According to the present disclosure, there is provided a communication device. The communication device includes the ToF (time of flight) sensor and the control unit. The ToF sensor includes the light emitting unit that emits light to the object to be measured and the light receiving unit that receives light reflected from the object to be measured. The control unit controls the ToF sensor. Furthermore, the control unit emits the light for a linking request to the other communication device, from the light emitting unit, and receives light being a response to the linking request from the other communication device, at the light receiving unit.

### Advantageous Effects of Invention

According to the present disclosure, a connection operation between communication devices can be simplified. It should be noted that the effects described herein are not necessarily limited, and any of effects described in the present disclosure may be provided.

### BRIEF DESCRIPTION OF DRAWINGS

FIG. 1 is a block diagram illustrating a schematic configuration example of a communication device according to an embodiment of the present disclosure.

FIG. 2 is a block diagram illustrating a schematic configuration example of a solid-state imaging device as a light receiving unit according to an embodiment of the present disclosure.

FIG. 3 is a graph for illustrating the overview of a distance measurement method by an indirect ToF method.

FIG. 4 is a graph for illustrating the overview of the distance measurement method by the indirect ToF method.

FIG. 5 is a diagram for illustrating a communication method according to an embodiment of the present disclosure.

FIG. 6 is a diagram for illustrating the communication method according to the embodiment of the present disclosure.

FIG. 7 is a diagram for illustrating the communication method according to the embodiment of the present disclosure.

FIG. 8 is a diagram for illustrating the communication method according to the embodiment of the present disclosure.

FIG. 9 is a diagram for illustrating a communication method according to a modification of the embodiment of the present disclosure.

FIG. 10 is a diagram for illustrating a communication method according to a modification of the embodiment of the present disclosure.

FIG. 11 is a flowchart illustrating a communication process procedure according to an embodiment of the present disclosure.

FIG. 12 is a flowchart illustrating a communication process procedure according to a modification of the embodiment of the present disclosure.

### DESCRIPTION OF EMBODIMENTS

Embodiments of the present disclosure will be described below in detail with reference to the drawings. Note that in the following embodiments, the same portions are denoted by the same reference numerals and symbols, and redundant description thereof will be omitted.

There is known a technology for performing a predetermined connection operation to transmit and receive data between a plurality of communication devices. However, in the above technology, for example, two communication terminal devices need to be swung multiple times while being held integrally in connection operation, the above technology requires complicated connection operation, and it is cumbersome for the user to perform the connection operation.

Therefore, it is expected to achieve a communication device and a communication method that are configured to simplify a connection operation between communication devices, overcoming the above problems.

[Overview of Communication Device]

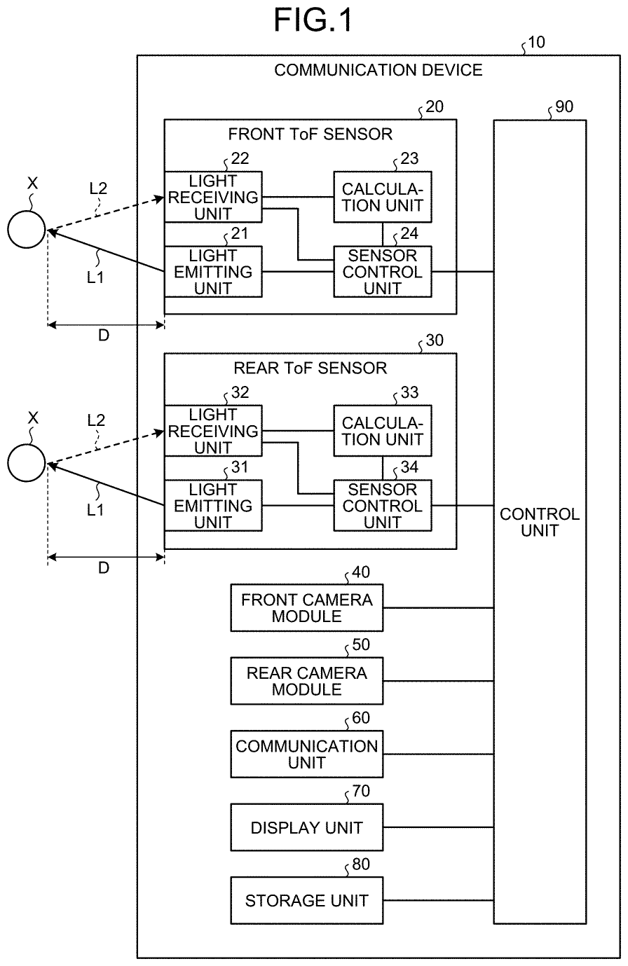

First, an overview of a communication device 10 according to an embodiment will be described with reference to FIG. 1. FIG. 1 is a block diagram illustrating a schematic configuration example of the communication device 10 according to the embodiment. The communication device 10 according to the embodiment is, for example, a portable wireless terminal such as a smartphone or a tablet terminal.

As illustrated in FIG. 1, the communication device 10 according to the embodiment includes a front ToF sensor 20, a rear ToF sensor 30, a front camera module 40, a rear camera module 50, a communication unit 60, a display unit 70, a storage unit 80, and a control unit 90.

Note that the front ToF sensor 20 and the rear ToF sensor 30 are examples of a ToF sensor, and the front camera module 40 and the rear camera module 50 are examples of a camera module.

The front ToF sensor 20 is provided on a front surface of a housing of the communication device 10 to measure a distance D to an object X to be measured located on the front surface side of the communication device 10. The front ToF sensor 20 includes a light emitting unit 21, a light receiving unit 22, a calculation unit 23, and a sensor control unit 24.

For example, the light emitting unit 21 includes, one or a plurality of semiconductor laser diodes as light sources to emit pulsed laser light (hereinafter, referred to as emission light) L1 having a predetermined time width, at a predetermined cycle (also referred to as a light emission cycle).

The light emitting unit 21 emits the emission light L1 at least toward an angle range equal to or larger than an angle of view of the light receiving unit 22. For example, the light emitting unit 21 emits the emission light L1 having a time width of several nanoseconds to 5 ns, at a 100 MHz cycle. For example, when the object X to be measured is located within a distance measurement range, the emission light L1 emitted from the light emitting unit 21 is reflected by the object X to be measured and incident as reflection light L2 on the light receiving unit 22.

The light receiving unit 22 includes, for example, a plurality of pixels arranged in a two-dimensional grid, and outputs signal intensity (Hereinafter, also referred to as a pixel signal) detected in each pixel after light emission from the light emitting unit 21. Details of this light receiving unit 22 will be described later.

The calculation unit 23 generates a depth image within the angle of view of the light receiving unit 22, on the basis of the pixel signal output from the light receiving unit 22. At that time, the calculation unit 23 may perform predetermined processing, such as noise removal, on the generated depth image. The depth image generated by the calculation unit 23 is output, for example, to the control unit 90 or the like via the sensor control unit 24.

The sensor control unit 24 includes, for example, an information processing device, such as a central processing unit (CPU), and controls each unit of the front ToF sensor 20.

The rear ToF sensor 30 is provided on a back surface of the housing of the communication device 10 to measure the distance D to the object X to be measured located on the back surface side of the communication device 10. The rear ToF sensor 30 includes a light emitting unit 31, a light receiving unit 32, a calculation unit 33, and a sensor control unit 34.

For example, the light emitting unit 31 includes, one or a plurality of semiconductor laser diodes as light sources to emit the pulsed emission light L1 having a predetermined time width, at a predetermined cycle.

The light emitting unit 31 emits the emission light L1 at least toward an angle range equal to or larger than an angle of view of the light receiving unit 32. For example, the light emitting unit 31 emits the emission light L1 having a time width of several nanoseconds to 5 ns, at a 100 MHz cycle. For example, when the object X to be measured is located within a distance measurement range, the emission light L1 emitted from the light emitting unit 31 is reflected by the object X to be measured and incident as the reflection light L2 on the light receiving unit 32.

The light receiving unit 32 includes, for example, a plurality of pixels arranged in a two-dimensional grid, and outputs a pixel signal detected in each pixel after light emission from the light emitting unit 31. Note that the light receiving unit 32 has a similar configuration to the light receiving unit 22 described above.

The calculation unit 33 generates a depth image within the angle of view of the light receiving unit 32, on the basis of the pixel signal output from the light receiving unit 32. At that time, the calculation unit 33 may perform predetermined processing, such as noise removal, on the generated depth image. The depth image generated by the calculation unit 33 is output, for example, to the control unit 90 or the like via the sensor control unit 34.

The sensor control unit 34 includes, for example, an information processing device, such as a central processing unit (CPU), and controls each unit of the rear ToF sensor 30.

The front camera module 40 is provided on the front surface of the housing of the communication device 10 to capture an image of the front surface side of the communication device 10. The front camera module 40 outputs image data of the captured image to the control unit 90.

The front camera module 40 includes a control circuit, a lens, an image sensor, and the like, which are not illustrated. When the communication device 10 is operated to perform a camera function on the front surface side, the control unit 90 activates the control circuit and the image sensor of the front camera module 40. Then, when image data based on a signal output from the image sensor is input to the control unit 90, a preview image corresponding to an object is displayed on the display unit 70.

The rear camera module 50 is provided on the back surface of the housing of the communication device 10 to capture an image of the back surface side of the communication device 10. The rear camera module 50 outputs image data of the captured image to the control unit 90.

The rear camera module 50 includes a control circuit, a lens, an image sensor, and the like, which are not illustrated. When the communication device 10 is operated to perform a camera function on the back surface side, the control unit 90 activates the control circuit and the image sensor of the rear camera module 50. Then, when image data based on a signal output from the image sensor is input to the control unit 90, a preview image corresponding to an object is displayed on the display unit 70.

The communication unit 60 is configured to communicate with any server device via a wireless communication network such as 3G (generation), long term evolution (LTE), or 5G new radio (NR).

Furthermore, the communication unit 60 is configured to perform proximity communication with another communication device 10 by a near-field communication technology. For example, the communication unit 60 is configured to perform the proximity communication with another communication device 10 by appropriately using various technologies related to wireless communication such as WiFi (registered trademark), Bluetooth (registered trademark), and near field communication (NFC).

For example, the display unit 70 is a display device such as a liquid crystal display panel, plasma display panel, or organic electro luminescence (EL) display panel. The display unit 70 displays an image on the basis of control of the control unit 90.

Furthermore, adopting a touch panel for the display unit 70, the display unit 70 can also serve as an input unit that receives various operations from the user. Note that, in the following description, the display unit 70 may be referred to as a “screen”.

The storage unit 80 is implemented by semiconductor memory device such as random access memory (RAM) or flash memory, or a storage device such as a hard disk or optical disk.

The control unit 90 is a controller, and is implemented by, for example, executing various programs stored in the storage unit 80 with the RAM as a working area by a central processing unit (CPU), a micro processing unit (MPU), or the like.

In addition, the control unit 90 is a controller, and is implemented by an integrated circuit such as an application specific integrated circuit (ASIC) or a field programmable gate array (FPGA).

[Configuration of Light Receiving Unit]

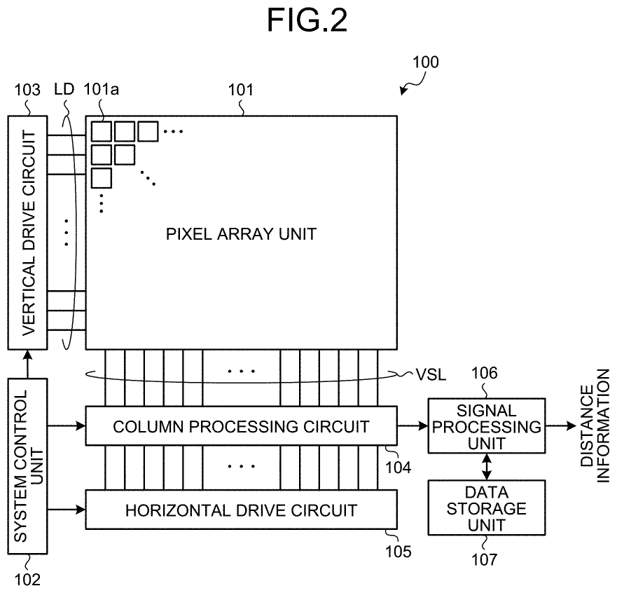

Next, configurations of the light receiving unit 22 of the front ToF sensor 20 and the light receiving unit 32 of the rear ToF sensor 30 according to an embodiment will be described with reference to FIGS. 2 to 4.

FIG. 2 is a block diagram illustrating a schematic configuration example of a solid-state imaging device 100 as the light receiving units 22 and 32 according to the embodiment. The solid-state imaging device 100 illustrated in FIG. 2 is an indirect ToF sensor of back illuminated type.

The solid-state imaging device 100 includes a pixel array unit 101 and peripheral circuits. The peripheral circuits can include, for example, a vertical drive circuit 103, a column processing circuit 104, a horizontal drive circuit 105, and a system control unit 102.

The solid-state imaging device 100 further includes a signal processing unit 106 and a data storage unit 107. Note that the signal processing unit 106 and the data storage unit 107 may be mounted on the same substrate as the solid-state imaging device 100, or may be arranged on a substrate different from the solid-state imaging device 100.

The pixel array unit 101 has a configuration in which pixels (hereinafter, also referred to as unit pixels) 101a each generating electrical charge according to an amount of light received and outputting a signal according to the electrical charge are arranged in row and column directions, that is, in a matrix (also referred to as two-dimensional grid).

Here, the row direction represents an arrangement direction (a horizontal direction in the drawing) of unit pixels 101a in a pixel row, and the column direction represents an arrangement direction (a vertical direction in the drawing) of unit pixels 101a in a pixel column.

In the pixel array unit 101, a pixel drive line

LD is wired in the row direction for each pixel row and two vertical signal lines VSL are wired in the column direction for each pixel column, for a pixel array in the matrix. The pixel drive line LD transmits a drive signal for performing driving to read a signal from the unit pixel 101a.

Note that, in FIG. 2, the pixel drive line LD is illustrated as one wiring, but is not limited to one. The pixel drive line LD has one end that is connected to an output end of the vertical drive circuit 103 corresponding to each row.

The vertical drive circuit 103 includes a shift register, an address decoder, and the like, and drives all the unit pixels 101a of the pixel array unit 101 simultaneously or unit pixels 101a in each row. In other words, the vertical drive circuit 103 constitutes a drive unit that controls the operation of each unit pixel 101a of the pixel array unit 101, together with the system control unit 102 that controls the vertical drive circuit 103.

Note that, in distance measurement by an indirect ToF method, the number of elements connected to one pixel drive line LD to be driven at high speed affects controllability of high-speed driving or accuracy in driving. Here, the pixel array unit of the solid-state imaging device used for distance measurement by the indirect ToF method often has a rectangular area elongated in the row direction.

Therefore, in such a configuration, each of the vertical signal lines VSL, or another control line extending in the column direction may be used for the pixel drive line LD for the elements to be driven at high speed. In such a configuration, for example, a plurality of the unit pixels 101a arranged in the column direction is connected to the vertical signal line VSL, or the another control line extending in the column direction.

Then, driving of the unit pixels 101a, that is, driving of the solid-state imaging device 100 is performed by a drive unit, the horizontal drive circuit 105, or the like, via the vertical signal line VSL or the another control line. The drive unit is separately provided from the vertical drive circuit 103.

A signal output from each unit pixel 101a in the pixel row, according to drive control by the vertical drive circuit 103, is input to the column processing circuit 104 through the vertical signal line VSL. The column processing circuit 104 performs predetermined signal processing on the signal output from each unit pixel 101a through the vertical signal line VSL, and temporarily holds the pixel signal after the signal processing.

Specifically, the column processing circuit 104 performs noise removal processing, analog to digital (AD) conversion processing, and the like as the signal processing.

The horizontal drive circuit 105 includes a shift register, an address decoder, and the like, and sequentially selects unit circuits of the column processing circuit 104 corresponding to the pixel columns. This selection scanning by the horizontal drive circuit 105 causes sequential output of the pixel signals obtained by signal processing in each unit circuit, in the column processing circuit 104.

The system control unit 102 includes a timing generator that generates various timing signals, and the like to perform drive control of the vertical drive circuit 103, the column processing circuit 104, the horizontal drive circuit 105, and the like, on the basis of the various timing signals generated by the timing generator.

The signal processing unit 106 has at least an arithmetic processing function, performs various signal processing, such as arithmetic processing, on the basis of the pixel signal output from the column processing circuit 104, and outputs distance information for each pixel calculated by the signal processing to the outside. For the signal processing in the signal processing unit 106, the data storage unit 107 temporarily stores data necessary for the signal processing.

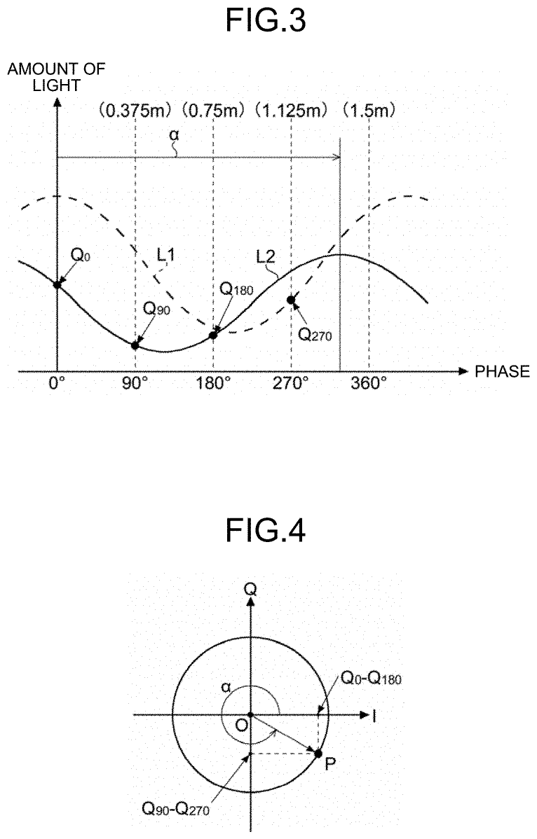

FIGS. 3 and 4 are each a graph for illustrating the overview of a distance measurement method by the indirect ToF method. As illustrated in FIG. 3, in the indirect ToF method, an amount of light Q₀, an amount of light Q₉₀, an amount of light Q₁₈₀, and an amount of light Q₂₇₀ are detected by the light receiving unit 22.

Here, the amount of light Q₀ represents an amount of reflection light L2 having a phase angle (also referred to as phase difference) of 0 degree relative to the emission light L1 emitted from the light emitting unit 21, and the amount of light Q₉₀ is an amount of reflection light L2 having a phase angle of 90 degrees relative to the emission light L1 emitted from the light emitting unit 21.

The amount of light Q₁₈₀ represents an amount of reflection light L2 having a phase angle of 180 degrees relative to the emission light L1 emitted from the light emitting unit 21, and the amount of light Q₂₇₀ represents an amount of reflection light L2 having a phase angle of 270 degrees relative to the emission light L1 emitted from the light emitting unit 21. Note that the phase here is a phase angle between a pulse of the emission light L1 and the pulse of the reflection light L2.

A phase angle α in pulse of the reflection light L2 relative to the emission light L1 can be expressed using, for example, a circle as illustrated in FIG. 4. In FIG. 4, the horizontal axis represents a difference between the amount of light Q₀ of the reflection light L2 having a phase angle of 0 degrees and the amount of light Q₁₈₀ of the reflection light L2 having a phase angle of 180 degrees, and the vertical axis represents a difference between the amount of light Q₉₀ of the reflection light L2 having a phase angle of 90 degrees and the amount of light Q₂₇₀ of the reflection light L2 having a phase angle of 270 degrees.

Then, the phase angle α can be calculated, for example, by substituting the amounts of light Q₀, Q₉₀, Q₁₈₀, and Q₂₇₀ detected as described above into the following formula (1).

α=Arctan((Q₉₀−Q₂₇₀)/(Q₀−Q₁₈₀)) (1)

Here, the phase angle α in pulse of the reflection light L2 relative to the emission light L1 corresponds to reciprocation of the pulse over the distance D to the object X to be measured from each of the front ToF sensor 20 and the rear ToF sensor 30.

Therefore, the distance D to the object X to be measured from each of the front ToF sensor 20 and the rear ToF sensor 30 can be calculated by substituting the phase angle α calculated according to formula (1) into the following formula (2).

D=(c·Δt)/2=(c·α)/2ω=(c·α)/4πf_{mod} (2)

In formula (2), Δt is a time difference from emission of the emission light L1 to reception of the reflection light L2, ω is an angular frequency of a modulation frequency f_{mod}, and c is a speed of light.

However, in the above method, degeneracy in the uncertainty of 360 degree phase angle makes it impossible to accurately measure the distance D to the object X to be measured having a phase angle α exceeding 360 degrees.

For example, when the modulation frequency f_{mod} of the emission light L1 is 100 MHz, the distance D to the object X to be measured that is at a position exceeding approximately 1.5 m away cannot be obtained, in consideration of reciprocation over the distance to the object X to be measured.

Therefore, in such a case, the distance to the object X to be measured is measured using different modulation frequency f_{mod}. Therefore, the degeneracy can be lifted on the basis of a result of the distance measurement, and thus, the distance D to the object X to be measured located at a certain distance or more can be also determined.

In this way, in the front ToF sensor 20 and the rear ToF sensor 30, four types of phase information of 0 degrees, 90 degrees, 180 degrees, and 270 degrees are acquired to create one depth image.

As described above, the light emitting units 21 and 31 of the ToF sensors according to the embodiment are each configured to emit the emission light L1 appropriately switched to have a plurality of modulation frequencies. Furthermore, the light receiving units 22 and 32 of the ToF sensors according to the embodiment are each configured to receive the reflection light L2 corresponding to the emission light L1 having a switched modulation frequency.

[Details of Communication Method]

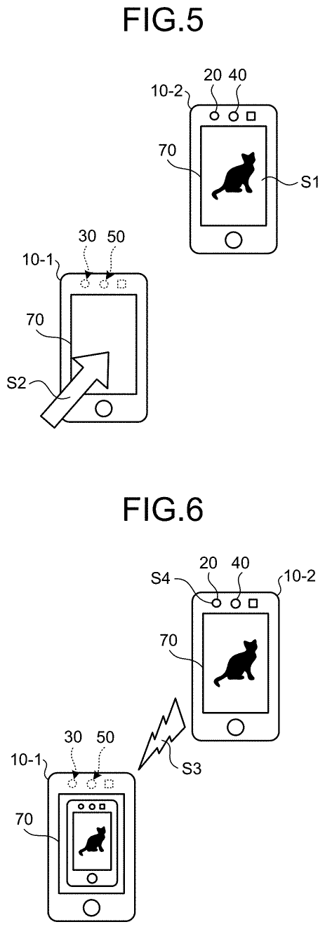

Next, details of the communication method according to an embodiment will be described with reference to FIGS. 5 to 8. FIGS. 5 to 8 are each a diagram illustrating an example of the communication method according to the embodiment of the present disclosure. Here, an example will be described in which a connection operation is performed between the two communication devices 10-1 and 10-2 and the user of the communication device 10-1 has data of an image (an image of a cat in the figure) transferred. The image is stored in the communication device 10-2.

First, in each of the communication device 10-1 and the communication device 10-2, a data sharing application is activated (Step S1). For example, in the communication device 10-2, an image that is desired to be transferred to the communication device 10-1 is displayed on the display unit 70 in this data sharing application.

Next, the communication device 10-1 and the communication device 10-2 are arranged so as to approach each other (Step S2). For example, in the example of FIG. 5, the communication device 10-1 is held over the communication device 10-2 so that the back surface of the communication device 10-1 faces the front surface of the communication device 10-2.

Therefore the rear ToF sensor 30 of the communication device 10-1 faces the front ToF sensor 20 of the communication device 10-2. Note that, in the following drawings, the rear ToF sensor 30 and the rear camera module 50 that are provided on the back surface of the communication device 10-1 are represented by broken lines, for ease of understanding.

Next, as illustrated in FIG. 6, predetermined processing, which is described later, triggers emission of light for a linking request to the communication device 10-2, by the communication device 10-1 (Step S3). For example, the predetermined processing triggers emission of emission light L1 for linking request to the communication device 10-2 from the light emitting unit 31 of the rear ToF sensor 30, by the control unit 90 of the communication device 10-1.

As the processing of triggering the linking request to the communication device 10-2 includes, for example, a predetermined instruction from the user. For example, when the user presses a button (not illustrated) displayed on the display unit 70 in an application activated on the communication device 10-1, the control unit 90 enables emission of light for a linking request to the communication device 10-2 from the light emitting unit 31.

Furthermore, when the user presses various buttons physically provided in the communication device 10-1, the control unit 90 enables emission of light for a linking request to the communication device 10-2 from the light emitting unit 31.

In this manner, by emitting the light for a linking request on the basis of the instruction from the user, the intention of the user can be reliably reflected in a linking process. Therefore, according to the embodiment, it is possible to suppress wrong linking process between the communication device 10-1 and the communication device 10-2.

Furthermore, the control unit 90 may use information about the distance D between the communication device 10-1 and the communication device 10-2 to trigger the linking request for the communication device 10-2.

For example, when the distance D between the communication device 10-1 and the communication device 10-2 is equal to or less than a predetermined distance, the control unit 90 enables emission of light for a linking request to the communication device 10-2 from the light emitting unit 31. Note that the control unit 90 is configured to use the rear ToF sensor 30 of the communication device 10-1 to measure the distance D between the communication device 10-1 and the communication device 10-2.

Furthermore, the control unit 90 may estimate the distance D between the communication device 10-1 and the communication device 10-2, on the basis of information obtained from the rear camera module 50. For example, the control unit 90 is configured to estimate the distance D between the communication device 10-1 and the communication device 10-2, on the basis of the size of the communication device 10-2 stored in advance in the storage unit 80 and image data of the communication device 10-2 acquired from the rear camera module 50.

As described above, emitting the light for a linking request on the basis of the distance D between the communication device 10-1 and the communication device 10-2 enables the linking process only by bringing the communication device 10-1 closer to the communication device 10-2, in the embodiment. Therefore, according to the embodiment, the linking process between the communication device 10-1 and the communication device 10-2 can be simply advanced.

Note that, in the embodiment, when only the process of distance measurement is performed by the ToF sensor of the communication device 10, the process of distance measurement is performed by reducing the number of pixels to be used, and when the process of distance measurement and the process of linking are performed in parallel, both processes may be performed by increasing the number of pixels to be used.

Furthermore, the control unit 90 may use information acquired by the rear camera module 50 of the communication device 10-1 to trigger the linking request for the communication device 10-2. For example, as illustrated in FIG. 6, the user captures an image of the communication device 10-2 on which image data desired to be transferred is displayed by the rear camera module 50 of the communication device 10-1.

Then, for example, when a predetermined mark (not illustrated) in an application displayed on the display unit 70 of the communication device 10-2 is recognized, the control unit 90 enables emission of light for a linking request to the communication device 10-2 from the light emitting unit 31.

Furthermore, in a case where the rear camera module 50 has an AI function and the AI function recognizes that the image data displayed on the communication device 10-2 is desired to be transferred, the control unit 90 enables emission of light for a linking request to the communication device 10-2.

As described above, emitting the light for a linking request on the basis of the information acquired by the rear camera module 50 of the communication device 10-1 enables the linking process only by capturing an image of the communication device 10-2 by the communication device 10-1. Therefore, according to the embodiment, the linking process between the communication device 10-1 and the communication device 10-2 can be simply advanced.

Next, the communication device 10-2 receives the light for a linking request from the communication device 10-1 (Step S4). For example, the control unit 90 of the communication device 10-2 receives the emission light L1 for linking request that is emitted from the communication device 10-1, at the light receiving unit 22 of the front ToF sensor 20.

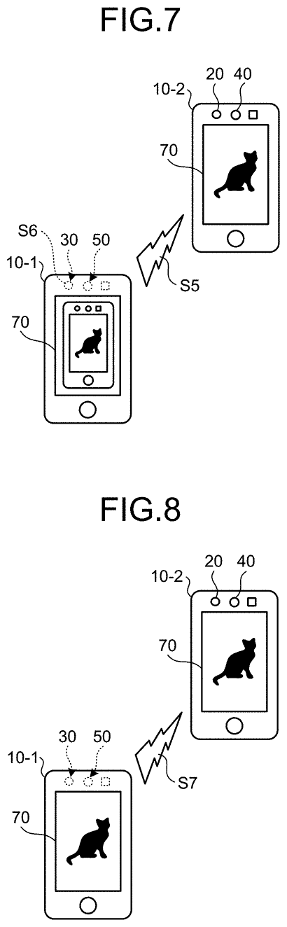

Next, as illustrated in FIG. 7, when the linking request from the communication device 10-1 is recognized, the control unit 90 of the communication device 10-2 emits light being a response to the linking request to the communication device 10-1 (Step S5).

For example, the control unit 90 of the communication device 10-2 emits emission light L1 indicating acceptance of the linking to the communication device 10-1, from the light emitting unit 21 of the front ToF sensor 20.

Then, the communication device 10-1 receives the light being a response to the linking request, from the communication device 10-2 (Step S6). For example, the control unit 90 of the communication device 10-1 receives the emission light L1 indicating acceptance of the linking from the communication device 10-2, at the light receiving unit 32 of the rear ToF sensor 30.

Then, the communication device 10-1 receives the light indicating acceptance of the linking from the communication device 10-2, whereby establishing link between the communication device 10-1 and the communication device 10-2.

As described above, in the embodiment, use of a plurality of ToF sensors for the indirect ToF method makes it possible to perform bidirectional communication. This is because the ToF sensors for the indirect ToF method can emit light switched to a plurality of modulation frequencies as appropriate and can receive light having the switched modulation frequencies.

Then, in the embodiment, the connection operation can be performed without complicated operation as described above by performing the linking process using the ToF sensors provided in a plurality of communication devices 10, and thus, the connection operation between the communication devices 10 can be simplified.

Furthermore, in the embodiment, the communication device 10 preferably includes the front ToF sensor 20 and the rear ToF sensor 30 on the front surface and the rear surface of the housing, respectively. This configuration makes it possible to perform bidirectional communication by using the ToF sensors provided in the plurality of communication devices 10, even if the plurality of communication devices 10 face each other in various directions.

Therefore, according to the embodiment, the user does not need to concern about the facing direction of the communication device 10 to perform the linking process, and thus, the connection operation between the communication devices 10 can be further simplified.

Note that, in the above description, the example has been described in which the plurality of ToF sensors (the front ToF sensor 20 and the rear ToF sensor 30) is provided in the communication device 10, but one ToF sensor may be provided in the communication device 10. In this configuration, either the front ToF sensor 20 or the rear ToF sensor 30 may be provided.

Description of processing after establishing link between the communication device 10-1 and the communication device 10-2 will be continued. The communication device 10-1 and the communication device 10-2 that have confirmed the locations thereof from each other determine optimal communication means for transmission of image data, on the basis of the capacity of the image data desired to be transferred, the distance D between the communication device 10-1 and the communication device 10-2, and the like.

Note that, at this time, the optimal communication means for transmission of the image data is preferably determined after confirming compatibility in communication function between the communication devices 10.

Then, when the optimum communication means for transmission of the image data is determined, the communication device 10-2 transfers the image data to the communication device 10-1 by using the optimum communication means (Step S7), as illustrated in FIG. 8. Therefore, the communication device 10-1 is allowed to receive such image data.

Note that, in Step S7, the communication device 10-2 may transfer the image data to the communication device 10-1 by using the front ToF sensor 20. For example, the control unit 90 of the communication device 10-2 emits the emission light L1 having the image data modulated to the communication device 10-1 from the front ToF sensor 20.

Then, the control unit 90 of the communication device 10-1 is configured to receive the image data by receiving the emission light L1 at the light receiving unit 32 of the rear ToF sensor 30.

As described above, in the embodiment, transmitting and receiving the image data by using the ToF sensors of the communication devices 10-1 and 10-2 makes it possible to transfer the image data without confirming the compatibility in the communication function between the communication devices 10. Therefore, according to the embodiment, the image data can be transferred without delay from the linking process.

Furthermore, in Step S7, the communication device 10-2 may transfer the image data to the communication device 10-1 by using the near-field communication technology that can be implemented by the communication unit 60. For example, the communication unit 60 of the communication device 10-2 can use a technology such as WiFi, Bluetooth, or NFC to transfer the image data to the communication unit 60 of the communication device 10-1.

As described above, transmitting and receiving the image data by using the near-field communication technology that can be implemented by the communication unit 60 makes it possible to efficiently transfer the image data, even in a case where the image data has a large capacity, in the embodiment.

Furthermore, in Step S7, the communication device 10-2 may cause the display unit 70 to display an identifier such as a 3D barcode thereon and the rear camera module 50 of the communication device 10-1 to read the identifier to transfer the image data to the communication device 10-1.

Note that, in the above embodiment, the example has been described in which the linking process is performed using the rear ToF sensor 30 of the communication device 10-1 and the front ToF sensor 20 of the communication device 10-2, but the linking process is not limited to be performed by the ToF sensors described above.

For example, the linking process may be performed using the front ToF sensor 20 of the communication device 10-1, or the linking process may be performed using the rear ToF sensor 30 of the communication device 10-2.

Furthermore, in the above embodiment, the example has been described in which the image data is transferred from the communication device 10-2 to the communication device 10-1, but the data to be transferred is not limited to the image data, and various data such as audio data, metadata, and payment information data may be transferred.

[Modifications]

In the embodiments described above, the linking process between the two communication devices 10 has been described, but the number of communication devices 10 configured to perform the linking process is not limited to two, and multilink can be also formed between three or more communication devices 10. Therefore, hereinafter, a multilink process of forming a multilink between three or more communication devices 10 will be described, as a modification.

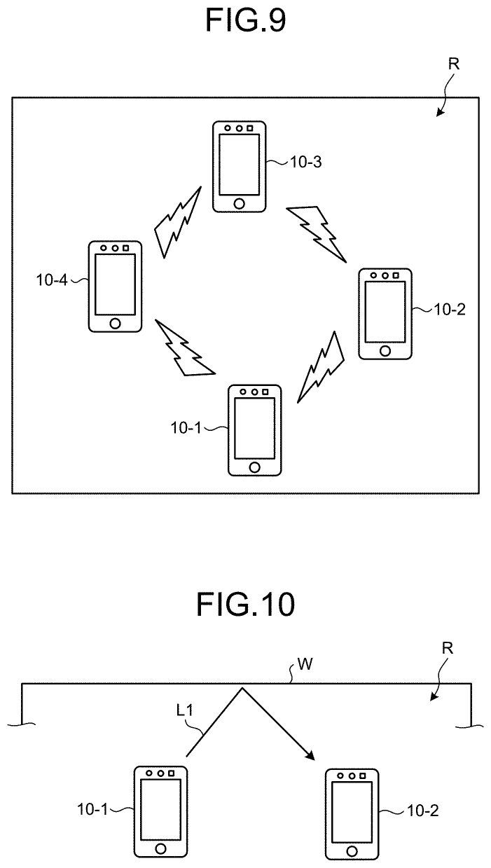

FIGS. 9 and 10 are each a diagram for illustrating a communication method according to a modification of the embodiment of the present disclosure. In the example of FIG. 9, the multilink process of forming a multilink between four communication devices 10-1 to 10-4 in a room R will be described.

In the example of FIG. 9, an application (e.g., a game application) that requires multilink between a plurality of communication devices 10 is activated in each communication device 10, first. Then, the predetermined processing described above triggers emission of light for a linking request to the other communication devices 10-2 to 10-4 from a ToF sensor by the communication device 10-1 serving as a master terminal.

Then, for example, when the communication device 10-2 receives the light for a linking request from the communication device 10-1, this communication device 10-2 emits light indicating acceptance of the linking, from the ToF sensor to the communication device 10-1. Furthermore, the communication device 10-2 emits light for a linking request to the other communication devices 10-3 and 10-4 from the ToF sensor.

Then, for example, when the communication device 10-3 receives the light for a linking request from the communication device 10-2, this communication device 10-3 emits light indicating acceptance of the linking, from the ToF sensor to the communication device 10-1 or the communication device 10-2. Furthermore, the communication device 10-3 emits light for a linking request to the other communication devices 10-4 from the ToF sensor.

As described above, in the modification, the ToF sensors of the plurality of communication devices 10 are preferably cooperatively lit to perform the multilink process while removing blind spot of the emission light L1 of the ToF sensor.

Furthermore, as illustrated in FIG. 10, when the communication device 10-1 and the communication device 10-2 face in the same direction, the communication device 10-1 is configured to perform the multilink process while eliminating the blind spot of the emission light L1 by reflecting the emission light L1 on a wall W.

Furthermore, the control unit 90 of the communication device 10-1 serving as the master terminal acquires position information of each of communication devices 10 on the basis of, for example, the light indicating acceptance of the linking that is transmitted from the other communication devices 10-2 to 10-4.

For example, the control unit 90 of the communication device 10-1 is configured to acquire the position information of each of communication devices 10 by using a technology such as simultaneous localization and mapping (SLAM).

Note that the multilink process of causing cooperative lighting of the ToF sensors of the respective communication devices 10 and the process of acquiring the position information of the respective communication devices 10, which have been described above, can be performed by cooperation between the control units 90 of the respective communication devices 10 and the activated applications.

Then, after the multilink has been established between the communication devices 10 and the position information of the communication devices 10 have been acquired, the applications are allowed to run between the communication devices 10 in a multilink state.

As described above, in the modifications, use of the ToF sensors provided in the respective communication devices 10 makes it possible to form the multilink between three or more communication devices 10 by the simple connection operation.

Note that, in the example of FIG. 9, the example has been described in which the multilink is formed between the four communication devices 10-1 to 10-4, but the number of communication devices 10 forming the multilink is not limited to four.

[Communication Process Procedures]

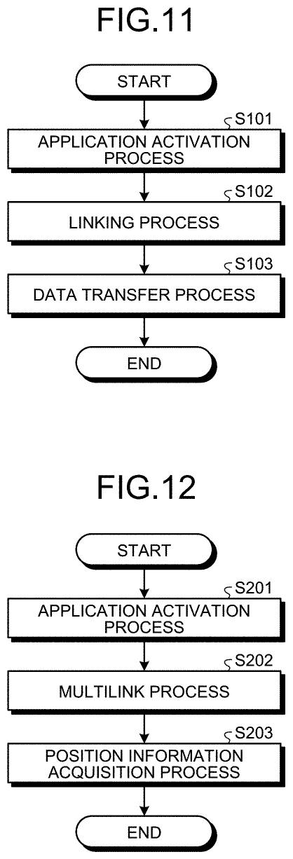

FIG. 11 is a flowchart illustrating a communication process procedure according to an embodiment of the present disclosure. First, the communication device 10-1 and the communication device 10-2 each perform an application activation process of activating an application (Step S101). For example, each of the communication device 10-1 and the communication device 10-2 starts the data sharing application.

Next, the communication device 10-1 and the communication device 10-2 perform the linking process of forming link between the communication device 10-1 and the communication device 10-2 (Step S102). For example, the predetermined processing triggers emission of light for a linking request, from the ToF sensor to the communication device 10-2 by the communication device 10-1 serving as the master terminal.

Then, the communication device 10-2 that has received the light for a linking request emits information indicating acceptance of the linking from the ToF sensor to the communication device 10-1. Furthermore, the communication device 10-2 receives the light indicating acceptance of the linking from the communication device 10-1, and the linking process between the communication device 10-1 and the communication device 10-2 is completed.

Next, the communication device 10-2 performs a data transfer process of transferring designated data to the communication device 10-1 (Step S103). For example, the communication device 10-2 may transfer the data to the communication device 10-1 by using the ToF sensor.

Furthermore, the communication device 10-2 may transfer data to the communication device 10-1 by using the near-field communication technology that can be implemented by the communication unit 60. When Step S103 as described above ends, the communication process according to the embodiment is completed.

FIG. 12 is a flowchart illustrating a communication process procedure according to a modification of the embodiment of the present disclosure. First, each of the communication devices 10-1 to 10-4 performs the application activation process of activating an application (Step S201). For example, the communication devices 10-1 to 10-4 each activate a game application.

Next, the communication devices 10-1 to 10-4 perform the multilink process of forming link between the communication devices 10-1 to 10-4 (Step S202). For example, the predetermined processing triggers emission of light for a linking request, from the ToF sensor to the communication devices 10-2 to 10-4 by the communication device 10-1 serving as the master terminal.

Then, the other communication devices 10 that have received the light for a linking request emit information indicating acceptance of the linking, from the ToF sensors to the communication device 10-1, and emit light for a linking request to the other communication devices 10 from the ToF sensors.

As described above, the ToF sensors of a plurality of the communication devices 10 are cooperatively lit, whereby the multilink process between all the communication devices 10-1 to 10-4 is completed.

Next, the communication device 10-1 serving as the master terminal performs position information acquisition process of acquiring the position information of each of communication devices 10, on the basis of the light indicating acceptance of the linking that is transmitted from the other communication devices 10-2 to 10-4 (Step S203). When Step S203 as described above ends, the communication process according to the modification of the embodiment is completed.

[Effects]

The communication device 10-1 according to the embodiment includes the ToF (time of flight) sensor (rear ToF sensor 30) and the control unit 90. The ToF sensor (rear ToF sensor 30) includes the light emitting unit 31 that emits light to the object X to be measured and the light receiving unit 32 that receives light reflected from the object X to be measured. The control unit 90 controls the ToF sensor (rear ToF sensor 30). Furthermore, the control unit 90 emits the light for a linking request to the other communication device 10-2, from the light emitting unit 31, and receives light being a response to the linking request from the other communication device 10-2, at the light receiving unit 32.

Therefore, the connection operation between the communication devices 10 can be simplified.

Furthermore, in the communication device 10-1 according to the embodiment, the light receiving unit 32 receives light being data transmitted from the other communication device 10-2, after link with the other communication device 10-2 is formed.

Therefore, the image data can be transferred without delay from the linking process.

Furthermore, the communication device 10-1 according to the embodiment further includes the communication unit 60 that receives the data from the other communication device 10-2 after link with the other communication device 10-2 is formed.

Therefore, even when the image data has a large capacity, the image data can be efficiently transferred.

Furthermore, in the communication device 10-1 according to the embodiment, the predetermined instruction from the user triggers emission of the light for a linking request to the other communication device 10-2 from the light emitting unit 31, by the control unit 90.

Therefore, it is possible to suppress wrong linking process between the communication device 10-1 and the communication device 10-2.

Furthermore, in the communication device 10-1 according to the embodiment, the distance D to the other communication device 10-2 that is equal to or less than the predetermined distance triggers emission of the light for a linking request to the other communication device 10-2 from the light emitting unit 31, by the control unit 90.

Therefore, the linking process between the communication device 10-1 and the communication device 10-2 can be simply advanced.

Furthermore, the communication device 10-1 according to the embodiment further includes the camera module (rear camera module 50) that images the object. Furthermore, the information acquired by the camera module (rear camera module 50) triggers emission of light for a linking request to the other communication device 10-2 from the light emitting unit 31, by the control unit 90.

Therefore, the linking process between the communication device 10-1 and the communication device 10-2 can be simply advanced.

Furthermore, the communication device 10-1 according to the embodiment includes the ToF sensors on the front and back surfaces of the housing.

Therefore, the user does not need to concern about the facing direction of the communication devices 10 to perform the linking process, and thus, the connection operation between the communication devices 10 can be further simplified.

The communication device 10-2 according to the embodiment includes the ToF (time of flight) sensor (front ToF sensor 20) and the control unit 90. The ToF sensor (front ToF sensor 20) includes the light emitting unit 21 that emits light to the object X to be measured and the light receiving unit 22 that receives light reflected from the object X to be measured. The control unit 90 controls the ToF sensor (front ToF sensor 20). Furthermore, the control unit 90 receives light for a linking request from the other communication device 10-1 at the light receiving unit 22, and emits light being a response to the linking request from the light emitting unit 21 to the other communication device 10-1.

Therefore, the connection operation between the communication devices 10 can be simplified.

Furthermore, in the communication device 10-2 according to the embodiment, the light emitting unit 21 emits light being data transmitted to the other communication device 10-1, after link with the other communication device 10-1 is formed.

Therefore, the image data can be transferred without delay from the linking process.

Furthermore, the communication device 10-2 according to the embodiment further includes the communication unit 60 that transmits the data to the other communication device 10-1 after link with the other communication device 10-1 is formed.

Therefore, even when the image data has a large capacity, the image data can be efficiently transferred.

Furthermore, the communication device 10-2 according to the embodiment includes the ToF sensors on the front and back surfaces of the housing.

Therefore, the user does not need to concern about the facing direction of the communication devices 10 to perform the linking process, and thus, the connection operation between the communication devices 10 can be further simplified.

The communication method according to the embodiment includes a light emitting step and a light receiving step. In the light emitting step, the light for a linking request to the other communication device 10-2 is emitted from the light emitting unit 31 of the ToF (time of flight) sensor (rear ToF sensor 30). In the light receiving step, the light being a response to the linking request emitted from the other communication device 10-2 is received at the light receiving unit 32 of the ToF sensor (rear ToF sensor 30).

Therefore, the connection operation between the communication devices 10 can be simplified.

The embodiments of the present disclosure have been described above, but the technical scope of the present disclosure is not limited to the embodiments described above, and various modifications and alterations can be made without departing from the spirit and scope of the present disclosure. Moreover, the component elements of different embodiments and modifications may be suitably combined with each other.

For example, in the above embodiments, the example has been described in which the linking process is performed using the front ToF sensor 20 and the rear ToF sensor 30, according to the indirect ToF method, but the linking process may be performed using a ToF sensor, according to the direct ToF method.

Furthermore, in the above embodiments, the example has been described in which the linking process between the communication devices 10 is performed after the data sharing application or the like is activated, but the linking process between the communication devices 10 may be performed without activating the application.

Furthermore, the effects described herein are merely examples, and the present disclosure is not limited to the effects but may have other effects.

Note that the present technology can also employ the following configurations.

(1)

A communication device comprising:

a ToF (time of flight) sensor that includes a light emitting unit emitting light to an object to be measured, and a light receiving unit receiving light reflected from the object to be measured; and

a control unit that controls the ToF sensor,

wherein the control unit

emits light for a linking request to another communication device, from the light emitting unit, and

receives the light being a response to the linking request from the another communication device at the light receiving unit.

(2)

The communication device according to (1), wherein

the light receiving unit receives light being data transmitted from the another communication device, after link with the another communication device is formed.

(3)

The communication device according to (1), further comprising

a communication unit that receives data from the another communication device, after link with the another communication device is formed.

(4)

The communication device according to any one of (1) to (3), wherein

a predetermined instruction from a user triggers emission of light for a linking request to the another communication device from the light emitting unit by the control unit.

(5)

The communication device according to any one of (1) to (3), wherein

a distance to the another communication device that is equal to or less than a predetermined distance triggers emission of light for a linking request to the another communication device from the light emitting unit by the control unit.

(6)

The communication device according to any one of (1) to (3), further comprising

a camera module that images an object,

wherein information acquired by the camera module triggers emission of light for a linking request to the another communication device from the light emitting unit by the control unit.

(7)

The communication device according to any one of (1) to (6), further comprising

the ToF sensor that is provided on each of a front surface and a back surface of the housing.

(8)

A communication device comprising:

a ToF (time of flight) sensor that includes a light emitting unit emitting light to an object to be measured, and a light receiving unit receiving light reflected from the object to be measured; and

a control unit that controls the ToF sensor,

wherein the control unit

receives light for a linking request from another communication device, at the light receiving unit, and

emits the light being a response to the linking request, to the another communication device from the light emitting unit.

(9)

The communication device according to (8), wherein

the light emitting unit emits light being data to the another communication device after link with the another communication device is formed.

(10)

The communication device according to (8), further comprising

a communication unit that transmits data to the another communication device, after link with the another communication device is formed.

(11)

The communication device according to any one of (8) to (10), further comprising

the ToF sensor that is provided on each of a front surface and a back surface of the housing.

(12)

A communication method comprising:

a light emitting step of emitting light for a linking request to another communication device from a light emitting unit of a ToF (time of flight) sensor; and

a light receiving step of receiving the light being a response to the linking request from the another communication device at a light receiving unit of the ToF sensor.

(13)

The communication method according to (12), further including

a light receiving step of receiving light being data transmitted from the another communication device, after link with the another communication device is formed.

(14)

The communication method according to (12), further including

a communication step of receiving data from the another communication device, after link with the another communication device is formed.

(15)

The communication method according to any one of (12) to (14), in which

in the light emitting step, a predetermined instruction from a user triggers emission of light for a linking request to the another communication device from the light emitting unit.

(16)

The communication method according to any one of (12) to (14), in which

in the light emitting step, a distance to the another communication device that is equal to or less than a predetermined distance triggers emission of light for a linking request to the another communication device from the light emitting unit.

(17)

The communication method according to any one of (12) to (14), in which

in the light emitting step, information acquired by a camera module that images an object triggers emission of light for a linking request to the another communication device from the light emitting unit.

(18)

A communication method including:

a light receiving step of receiving light for a linking request from another communication device at the light receiving unit; and

a light emitting step of emitting the light being a response to the linking request, from the light emitting unit to the another communication device.

(19)

The communication method according to (18), further including

a light emitting step of emitting light being data transmitted to the another communication device, after link with the another communication device is formed.

(20)

The communication method according to (18), further including

a communication step of transmitting data to the another communication device, after link with the another communication device is formed.

### REFERENCE SIGNS LIST

10 COMMUNICATION DEVICE
20 FRONT ToF SENSOR (EXAMPLE OF ToF SENSOR)
30 REAR ToF SENSOR (EXAMPLE OF ToF SENSOR)
40 FRONT CAMERA MODULE (EXAMPLE OF CAMERA MODULE)
50 REAR CAMERA MODULE (EXAMPLE OF CAMERA MODULE)
60 COMMUNICATION UNIT
90 CONTROL UNIT
L1 EMISSION LIGHT
L2 REFLECTION LIGHT

1. A communication device comprising:
a ToF (time of flight) sensor that includes a light emitting unit emitting light to an object to be measured, and a light receiving unit receiving light reflected from the object to be measured; and
a control unit that controls the ToF sensor,
wherein the control unit
emits light for a linking request to another communication device, from the light emitting unit, and
receives the light being a response to the linking request from the another communication device at the light receiving unit.

2. The communication device according to claim 1, wherein
the light receiving unit receives light being data transmitted from the another communication device, after link with the another communication device is formed.

3. The communication device according to claim 1, further comprising
a communication unit that receives data from the another communication device, after link with the another communication device is formed.

4. The communication device according to claim 1, wherein
a predetermined instruction from a user triggers emission of light for a linking request to the another communication device from the light emitting unit by the control unit.

5. The communication device according to claim 1, wherein
a distance to the another communication device that is equal to or less than a predetermined distance triggers emission of light for a linking request to the another communication device from the light emitting unit by the control unit.

6. The communication device according to claim 1, further comprising
a camera module that images an object,
wherein information acquired by the camera module triggers emission of light for a linking request to the another communication device from the light emitting unit by the control unit.

7. The communication device according to claim 1, further comprising
the ToF sensor that is provided on each of a front surface and a back surface of the housing.

8. A communication device comprising:
a ToF (time of flight) sensor that includes a light emitting unit emitting light to an object to be measured, and a light receiving unit receiving light reflected from the object to be measured; and
a control unit that controls the ToF sensor,
wherein the control unit
receives light for a linking request from another communication device, at the light receiving unit, and
emits the light being a response to the linking request, to the another communication device from the light emitting unit.

9. The communication device according to claim 8, wherein
the light emitting unit emits light being data to the another communication device after link with the another communication device is formed.

10. The communication device according to claim 8, further comprising
a communication unit that transmits data to the another communication device, after link with the another communication device is formed.

11. The communication device according to claim 8, further comprising
the ToF sensor that is provided on each of a front surface and a back surface of the housing.

12. A communication method comprising:
a light emitting step of emitting light for a linking request to another communication device from a light emitting unit of a ToF (time of flight) sensor; and
a light receiving step of receiving the light being a response to the linking request from the another communication device at a light receiving unit of the ToF sensor.
